(19) United States
(12) Patent Application Publication
(10) Pub. No.: US 2023/0332781 A1
(43) Pub. Date: Oct. 19, 2023

(54) WATER MISTING SYSTEM

(71) Applicant: Richard John Geer, London (CA)

(72) Inventor: Richard John Geer, London (CA)

(21) Appl. No.: 17/720,230

(22) Filed: Apr. 13, 2022

(51) Int. Cl. F24F 5/00; B05B 15/652; B05B 1/20; B05B 1/30

(52) U.S. Cl. CPC F24F 5/0035; B05B 15/652; B05B 1/205; B05B 1/3026

(57) ABSTRACT

A misting system includes at least one support pipe, at least one first water supply conduit, a first plurality of anti-drip misting nozzles and at least one first valve. In some embodiments, the misting system also includes a base including least one second water supply conduit, a second plurality of anti-drip misting nozzles, and at least one second valve. The first plurality of anti-drip misting nozzles provide general misting to an area and to (generally) an upper body of a user located about the area. The second plurality of anti-drip misting nozzles provide misting to (generally) a lower body of the user. Used together, the first plurality of anti-drip misting nozzles and the second plurality of anti-drip misting nozzles provide misting to the area, as well as full body misting to the user.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of cooling systems of existing art and more specifically relates to an easily installed and portable misting system.

### RELATED ART

Misting systems have been used for many years for a variety of reasons. Notably, misting systems are often used in hot climates to cool down an area, as well as individuals in that area. For example, many restaurants and outdoor malls employ misting systems for cooling down their customers. However, these misting systems are typically extremely expensive. As such, these misting systems are not viable options for personal use in homes.

Attempts have been made to provide inexpensive misting options for personal use. However, there are many disadvantages to these current systems. For example, these misting systems are often not built to last and are made from cheap materials. In addition to this, these misting systems do not provide on/off controls at the system, and thus, activation must be made at the garden hose tap. This may lead to excessive moisture around the deployment area if the misting system is inadvertently left on. Furthermore, when these systems are turned off, there is a period of heavy dripping as the misting nozzles are emptied. The systems also typically require a roof, overhang or pergola to attach the garden hose to and to install the system to. As such, a suitable solution is desired.

### SUMMARY OF THE INVENTION

In view of the foregoing disadvantages inherent in the known cooling and misting systems art, the present disclosure provides a novel misting system. The general purpose of the present disclosure, which will be described subsequently in greater detail, is to provide a system that is easily installed and portable. Preferably, the misting system is able to be used in various locations.

A misting system is disclosed herein. The misting system includes at least one support pipe, a first water supply input, at least one first water supply conduit, a first plurality of anti-drip misting nozzles, and at least one first valve. The first water supply input may be configured to receive water from the water supply. The at least one support pipe may be attached about a top surface of the base and may include at least one fastener configured to attach the misting system to a surface; a plurality of first misting apertures; and a first operator aperture.

The at least one first water supply conduit may be disposed within the at least one support pipe, in communication with the first water supply input and configured to convey said water therefrom. The first plurality of anti-drip misting nozzles may be arranged about the at least one first water supply conduit and configured to receive said water therefrom. Each first anti-drip misting nozzle may include a first conduit end opposite a first misting end. Each first misting end may be configured for insertion through a first misting aperture from the first plurality of misting apertures and to output said water therethrough.

The at least one first valve may be disposed along the at least one first water supply conduit. The at least one first valve may include a first valve operator configured for insertion through the first operator aperture such that the user is able to selectively manipulate the first valve operator to one of open the at least one first valve thereby allowing said water to flow through the at least one first valve and out of each first misting end of the first plurality of anti-drip misting nozzles, and close the at least one first valve thereby preventing said water from flowing through the at least one first valve.

According to another embodiment, a method of using a misting system for connection with a water supply is also disclosed herein. The method includes providing the misting system as above; connecting the water supply to the first water supply input; manipulating, when misting is desired, the first valve operator to open the at least one first valve, thereby causing said water to flow through the at least one first valve and out of each first misting end of the first plurality of anti-drip misting nozzles; and manipulating, when misting is not desired, the first valve operator to close the at least one first valve, thereby preventing said water to flow through the at least one first valve.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a water misting system, constructed and operative according to the teachings of the present disclosure.

FIG. 1 is a perspective view of a misting system being used to cool an area, according to an embodiment of the disclosure.

FIG. 2 is a cross-sectional view of the misting system including at least one support pipe, a first water supply input, at least one first water supply conduit, a first plurality of anti-drip misting nozzles and at least one first valve, according to an embodiment of the present disclosure.

FIG. 3 is a partial exploded view of the misting system of FIG. 2, according to an embodiment of the present disclosure.

FIG. 4 is a perspective view of a misting system being used to cool a pet, according to an embodiment of the disclosure.

FIG. 5 is a cross-sectional view of the misting system including a base, a second water supply input, at least one second water supply conduit, a second plurality of anti-drip misting nozzles and at least one second valve, according to an embodiment of the present disclosure.

FIG. 6 is a partial exploded view of the misting system of FIG. 5, according to an embodiment of the present disclosure.

FIG. 7 is a bottom view of the base illustrating a relationship between the at least one second water supply conduit, the second plurality of anti-drip misting nozzles and the at least one second valve, according to an embodiment of the present disclosure.

FIG. 8 is a front view of the misting system including a rain barrel, according to another embodiment of the present disclosure.

FIG. 9 is a front view of the misting system including a barbecue, according to another embodiment of the present disclosure.

FIG. 10 is a front view of the misting system including a professional barbecue, according to another embodiment of the present disclosure.

FIG. 11 is a flow diagram illustrating a method of using a misting system for connection with a water supply, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to cooling systems and more particularly to a misting system that is easily installed and portable. Generally, the misting system may easily attach to fences, decks, houses and/or may be placed in any location that a standard garden hose reaches to. The misting system may include a metered valve at the point of misting, allowing the misting system to be switched on and off directly. In some embodiments, the metered valve may include an expanded valve passageway to increase volume of water in the misting system and increase length of mist deployment. Preferably, anti-drip nozzles may be used so that the misting system remains charged with water between uses. This may prevent an area of deployment (an area being covered by the mist) from becoming saturated with excess water and provides for instant mist, rather than initial droplets, when the metered valve is opened.

The misting system may be easily installed to fences, decks, houses, etc. via two screws, or may be simply dropped onto a ground surface. The misting system may then be connected to a standard garden hose. As discussed above, the misting system may utilize a metered valve having a spring activated plunger that when pushed once, opens the metered valve and enables water to flow through the system and out of the anti-drip nozzles. Another push of the spring activated plunger may close the metered valve and thereby stop the mist from discharging from the anti-drip nozzles. Alternatively, holding the spring activated plunger in may provide a continuous mist until the spring activated plunger is released. Once the misting system is switched off, water may not leak from the anti-drip nozzles.

In some embodiments, the misting system may include a support pipe housing a conduit in fluid communication with the anti-drip nozzles and configured to convey water from the standard garden hose to the anti-drip nozzles. The anti-drip nozzles may be arranged such that the mist is generally directed about the deployment area, cooling the area and those around the area. In further embodiments, the misting system may include a base with a stand on design, in which a user may step on the base to activate misting from anti-drip nozzles arranged about the base. In some examples of this embodiment, the base may include a spring-loaded step. In other examples, the base may include a spring loaded button. This embodiment may be particularly useful when the user does not wish to mist their upper body or may be useful for pets; enabling the pet to step on the base to mist themselves.

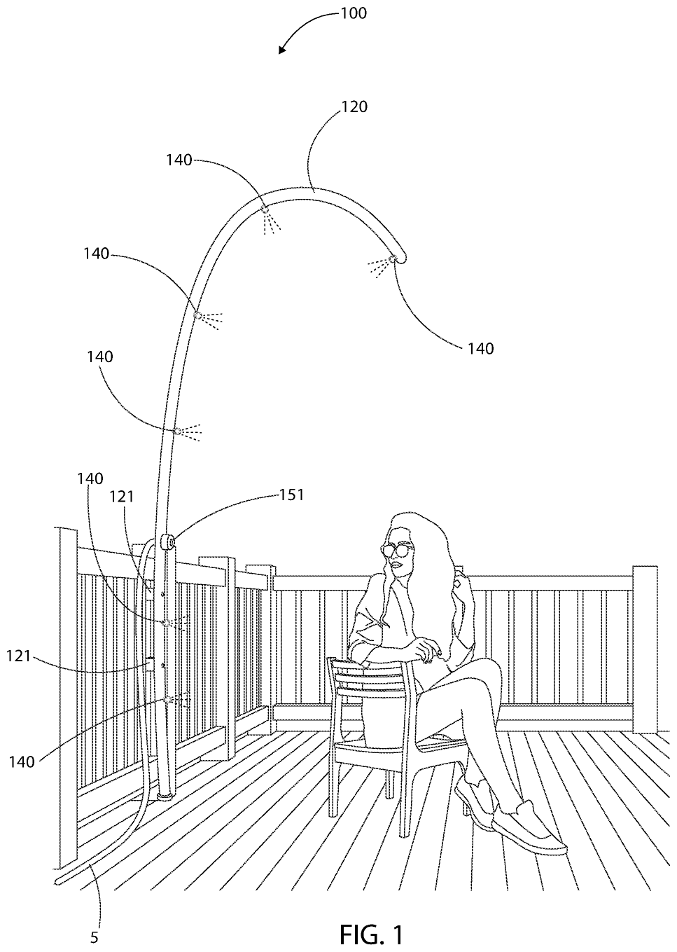

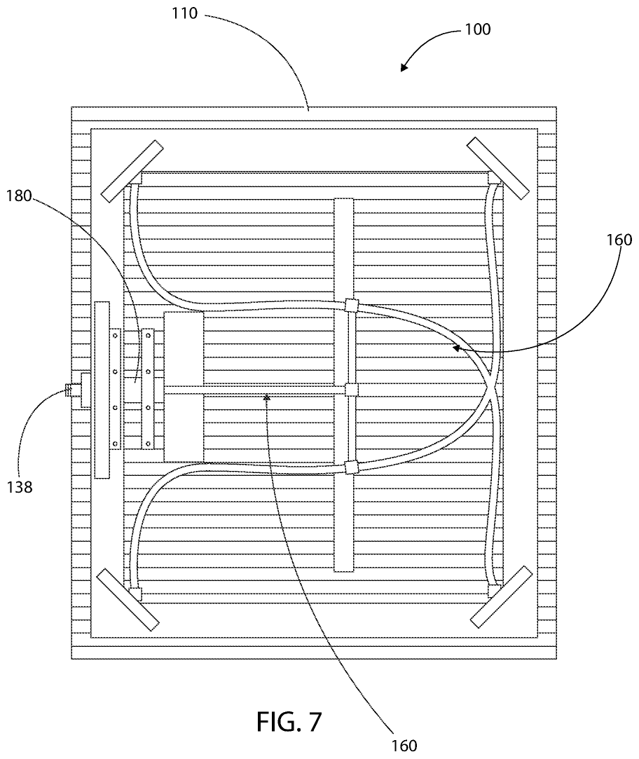

Referring now more specifically to the drawings by numerals of reference, there is shown in FIGS. 1-10, various views of a misting system 100. As shown in FIGS. 1-3, the misting system 100 may include at least one support pipe 120, a first water supply input 128, at least one first water supply conduit 130, a first plurality of anti-drip misting nozzles 140 and at least one first valve 150. The misting system 100 may be connected to a water supply 5. Preferably, as discussed above, the water supply 5 may be a standard garden hose. In these embodiments, the misting system 100 may be placed anywhere that the garden hose is able to reach, enabling great versatility and portability of the misting system 100. In other examples, the water supply 5 may be a standard outdoor faucet. Other water supply means may also be contemplated.

As shown in FIG. 1, the first water supply input 128 may be configured to receive water from the water supply 5. For example, the first water supply input 128 may include a hose connector. The hose connector may be configured to interface with any standard garden hose.

The at least one support pipe 120 may include at least one fastener 121 configured to attach the misting system 100 to a surface. As above, the misting system 100 may preferably be usable in many different locations. As such, the surface may be various different surfaces. For example, as shown in FIG. 1, the surface may be a fence. In other examples, the surface may a post, a deck, a planter, a barbecue, etc. In some examples, the at least one fastener 121 may include two screws 124. In some embodiments, the two screws 124 may each include a block mount 125 attached thereto. In other examples, the at least one fastener 121 may include cement/masonry anchors, metal self-tapping lag screws, etc.

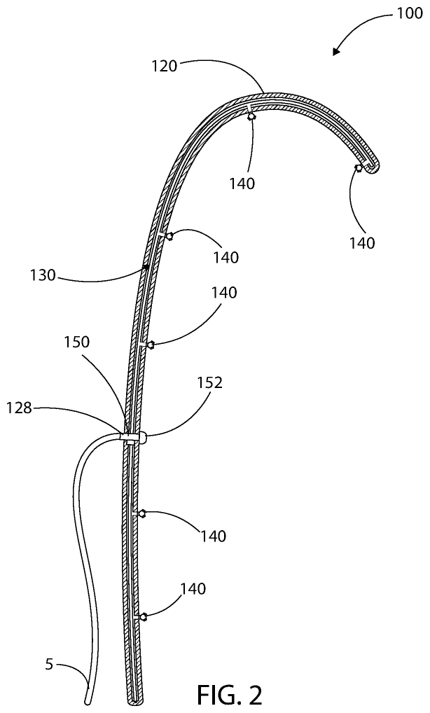

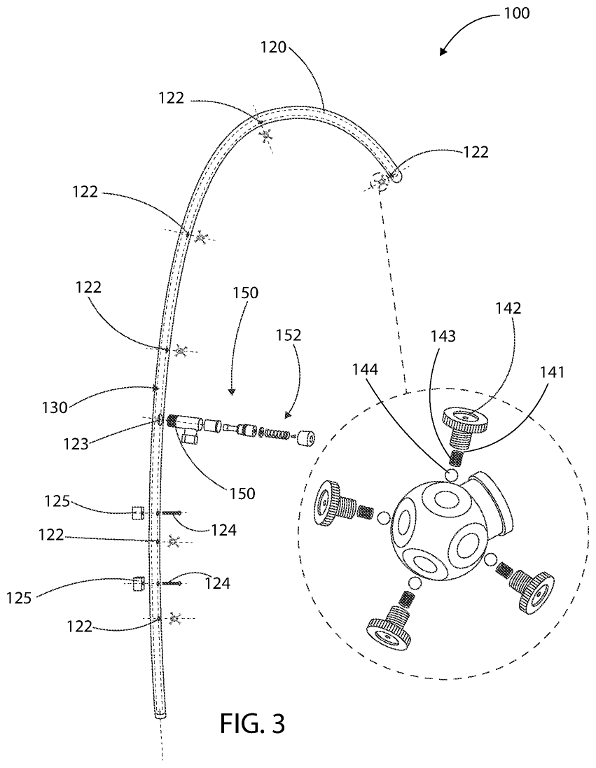

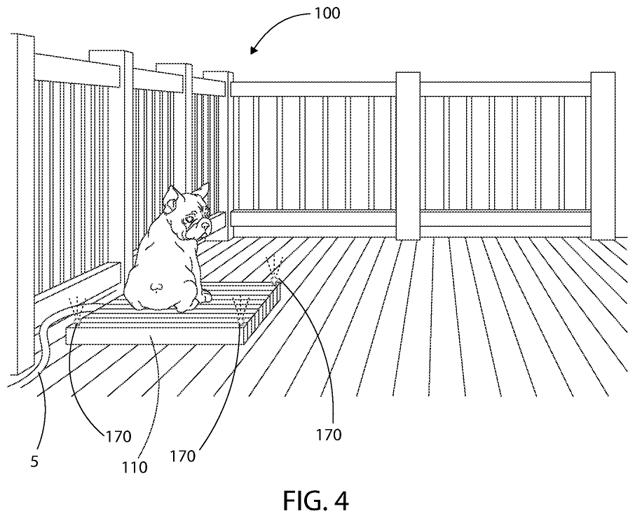

The at least one support pipe 120 may include a plurality of first misting apertures 122 and a first operator aperture 123. As shown in FIGS. 2-3, the at least one first water supply conduit 130 may be disposed within the at least one support pipe 120 (for the sake of clarity, FIG. 4 illustrates the at least one first water supply conduit 130 via dotted lines within the at least one support pipe 120). The at least one first water supply conduit 130 may be communication with the first water supply input 128 and configured to convey said water therefrom.

As shown in FIGS. 1-3, the first plurality of anti-drip misting nozzles 140 may be arranged about the at least one first water supply conduit 130. In some embodiments, the first plurality of anti-drip misting nozzles 140 may include, but is not limited to, six anti-drip misting nozzles spaced about the at least one first water supply conduit 130. In some embodiments, the at least one first water supply conduit 130 may be defined by a first inlet conduit 131 and a first misting conduit 132 in communication with the first inlet conduit 131.

The first plurality of anti-drip misting nozzles 140 may be configured to receive water from the at least one first water supply conduit 130. As shown in FIG. 4, each first anti-drip misting nozzle may include a first conduit end 141 opposite a first misting end 142. Each first conduit end 141 may be attached to the first misting conduit 132 (FIG. 3). As shown in FIG. 4, each first misting end 142 may be configured for insertion through a first misting aperture from the first plurality of misting apertures 122 and to output said water therethrough. Each first misting end 142 may include at least one dispensing aperture 145 to concentrate the water therethrough as a fine mist. For example, each at least one dispensing aperture 145 may include a diameter of between 0.020 mm-0.015 mm.

As shown in FIGS. 2-3, the at least one first valve 150 may be disposed along the at least one first water supply conduit 130. As shown, the at least one first valve 150 may include a first valve operator 151 configured for insertion through the first operator aperture 123 such that the user is able to selectively manipulate the first valve operator 151 to open the at least one first valve 150, thereby allowing the water to flow through the at least one first valve 150 (from the first inlet conduit 131, through the at least one first valve 150 and into the first misting conduit 132), and out of each first misting end 142 of the first plurality of anti-drip misting nozzles 140. The first valve operator 151 may also be manipulated to close the at least one first valve 150 thereby preventing said water from flowing through the at least one first valve 150 (effectively cutting of water supply to the first misting conduit 132).

In some embodiments, the first valve operator 151 may include a first spring loaded button 152. When the first spring loaded button 152 is pressed once or held in, the at least one first valve 150 may open. When the first spring loaded button 152 is pressed again, the at least one first valve 150 may close. For example, the at least one first valve 150 may include a first valve passageway and a plunger (not illustrated) configured to selectively seal the first valve passageway. The first spring loaded button 152 may be attached at an end of the plunger such that pressing the first spring loaded button 152 opens or closes the first valve passageway. Further, in some embodiments, the at least one first valve 150 may include the first water supply input 128.

In some embodiments, the at least one first valve 150 may include a metered valve. This may allow the misting system 100 to remain charged with water such that when the misting system 100 is turned on (the first valve operator 151 is manipulated to open the at least one first valve 150), the water is dispersed quickly and immediately as a fine mist, rather than as large droplets at first. To aid in this, the first plurality of anti-drip misting nozzles 140 may also allow the misting system 100 to remain charged with water whilst preventing water from inadvertently dripping from the first plurality of anti-drip misting nozzles 140. For example, in some embodiments, as shown in FIG. 4, the first conduit end 141 of each of the first plurality of anti-drip misting nozzles 140 may include a spring 143 and a sealer 144, such as a ball, that upon drop in pressure (when the at least one first valve 150 is closed), the sealer 144 moves to prevent the water from entering through the first misting end 142.

In some embodiments, as shown in FIGS. 4-7, a base 110 may be provided, which may be simultaneously with the misting system 100 discussed above or may be used separately. As such, the base may include a second water supply input 138. Similar to the first water supply input 128, the second water supply input 138 may include a hose connector. In other embodiments, the first water supply input 128 and the second water supply input 138 may be the same. For example, both inputs 128, 138 may be one hose connector. Further, at least one second water supply conduit 160 may be disposed within the base 110 (again, for the sake of clarity, FIG. 6 illustrates the at least one second water supply conduit 160 via dotted lines within the base 110). The at least one second water supply conduit 160 may also be in communication with the second water supply input 138 and configured to convey said water therefrom. In some embodiments, the at least one second water supply conduit 160 may be defined by a second inlet conduit 161 and a second misting conduit 162 in communication with the second inlet conduit 161.

As shown, the misting system 100 may further comprise a second plurality of anti-drip misting nozzles 170 arranged about the base 110 and connected to the at least one second water supply conduit 160 to receive the water therefrom. Each second anti-drip misting nozzles 170 may include a second conduit end 171 opposite a second misting end 172, each second misting end 172 may be configured for insertion through a second misting aperture from the second plurality of misting apertures 112 and configured to output said water therethrough.

In some embodiments, the first plurality of anti-drip misting nozzles 140 may be identical to the second plurality of anti-drip misting nozzles 170. As such, each second misting end 172 may include the at least one dispensing aperture 145 to concentrate the water therethrough as a fine mist and each may include the spring 143 and the sealer 144 as discussed above. As shown, in some embodiments, the second plurality of anti-drip misting nozzles 170 may include, but is not limited to, five anti-drip misting nozzles. For example, each corner of the base 110 may include one anti-drip misting nozzle and another may be located at a center of the base 110.

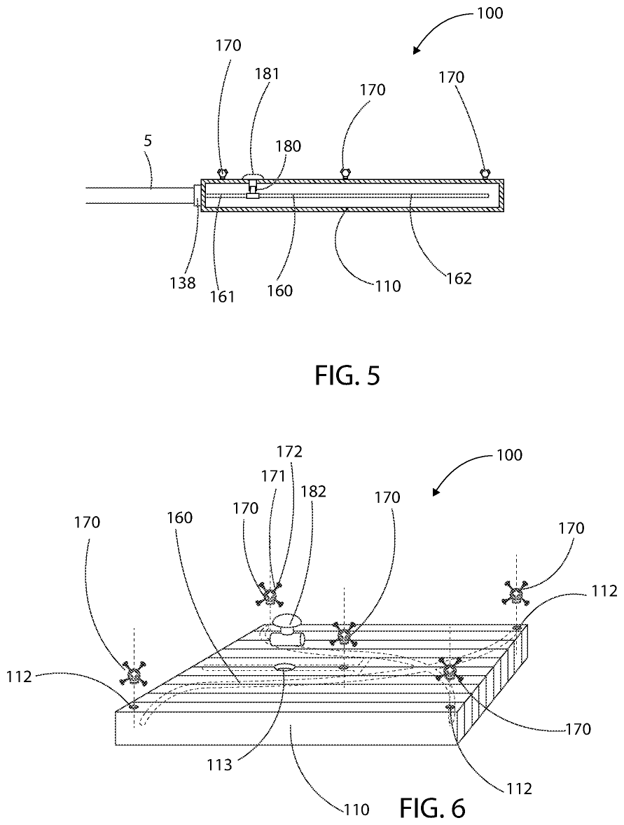

As shown in FIGS. 5-7, the at least one second valve 180 may be disposed along the at least one second water supply conduit 160. The at least one second valve 180 may include a second valve operator 181 configured for insertion through the second operator aperture 113 such that the user is able to selectively manipulate the second valve operator 181 to one of open the at least one second valve 180 thereby allowing said water to flow through the at least one second valve 180 (from the second inlet conduit 161, through the at least one second valve 180 and into the second misting conduit 162) and out of each misting end of the second plurality of anti-drip misting nozzles 170. The second valve operator 181 may also be used close the at least one second valve 180 thereby preventing said water from flowing through the at least one second valve 180 (effectively cutting off water supply 5 to the second misting conduit 162).

As shown in FIGS. 5-6, the second valve operator 181 may include a second spring loaded button 182. When weight is applied to the second spring loaded button 182, the at least one second valve 180 may open; and when weight is removed from the second spring loaded button 182, the at least one second valve 180 may close. For example, preferably, the user may stand on the second spring loaded button 182. As shown in FIG. 4, the user may, in some embodiments, be an animal. In some examples, the at least one second valve 180 may include a second valve passageway and a movable sealer (not illustrated) attached to the second spring loaded button 182. The movable sealer may seal the second valve passageway until weight is added to the second spring loaded button 182, whereby the movable sealer may then unseal the second valve passageway. In some embodiments, the movable sealer may automatically return to sealing the second valve passageway when the weight is removed from the second spring loaded button 182.

The use of the second plurality of anti-drip misting nozzles 170 alone may enable the user to receive mist about their feet and legs without misting their upper body. This may be particularly useful for users who do not wish to get their hair/face wet. The first plurality of anti-drip misting nozzles 140 and the second plurality of anti-drip misting nozzles 170 may be used at the same time for providing mist from head to toe and to cool an area. The first plurality of anti-drip misting nozzles 140 may be used alone to provide mist to (generally) the upper body of the user.

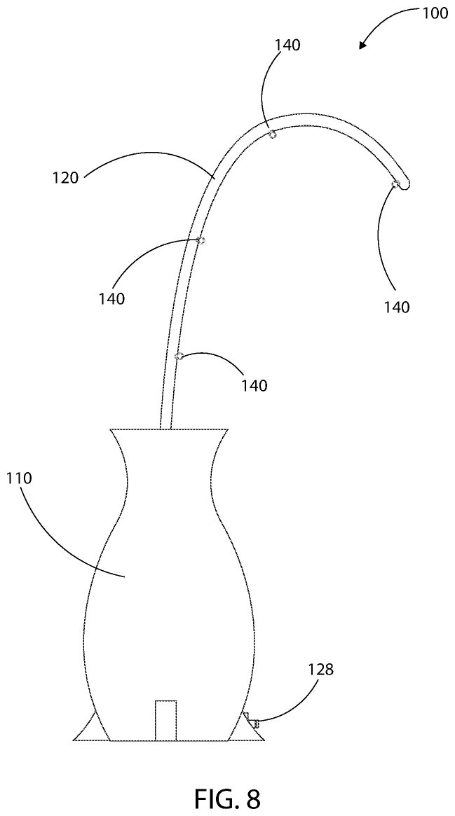

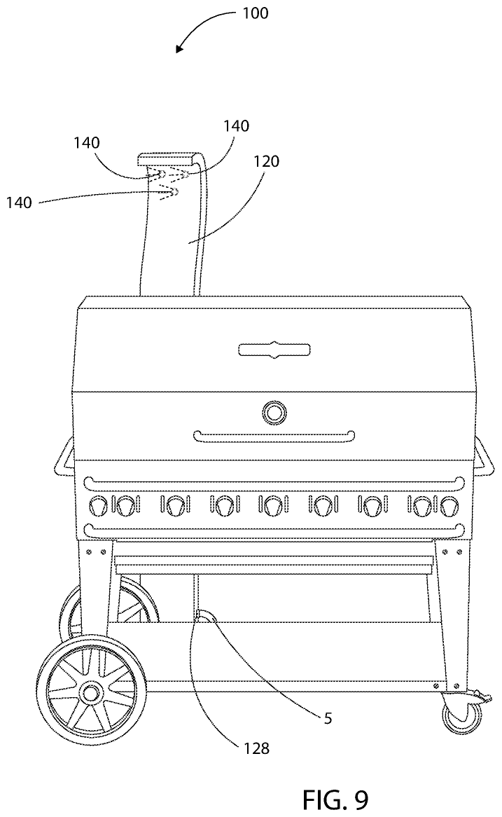

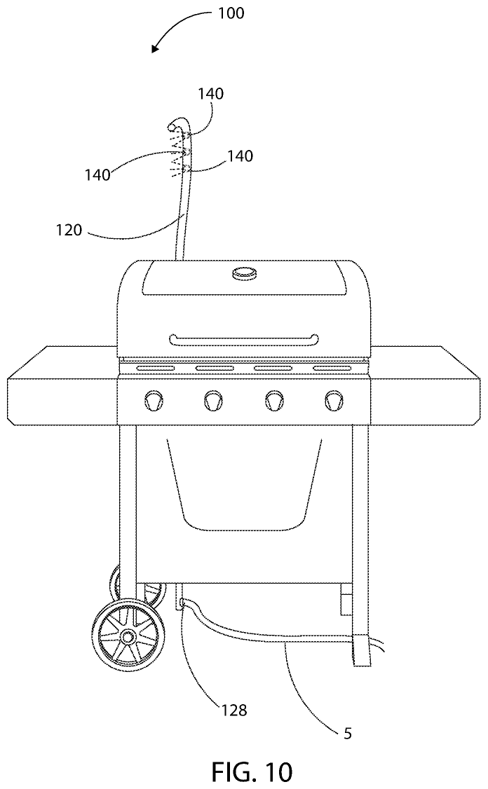

Referring now to FIGS. 8-10, there is shown the misting system 100 according to another embodiment of the present disclosure. As discussed above, the misting system 100 may preferably be usable in many different locations. For example, the misting system 100 may be used with a planter, a barbecue, and/or a rain barrel as shown in this figure. FIG. 8 illustrates the misting system 100 used in a rain barrel. For example, as shown, the base 110 may include the rain barrel used to support the at least one support pipe 120 therein. FIGS. 9-10 illustrate the misting system 100 used on a barbecue. FIG. 9 illustrates the at least one support 120 attached about a rear of the barbecue and including three anti-drip misting nozzles 140. FIG. 10 illustrates a professional barbecue embodiment. As shown, the at least one support pipe 120 may include a wider configuration and may also include three anti-drip misting nozzles 140.

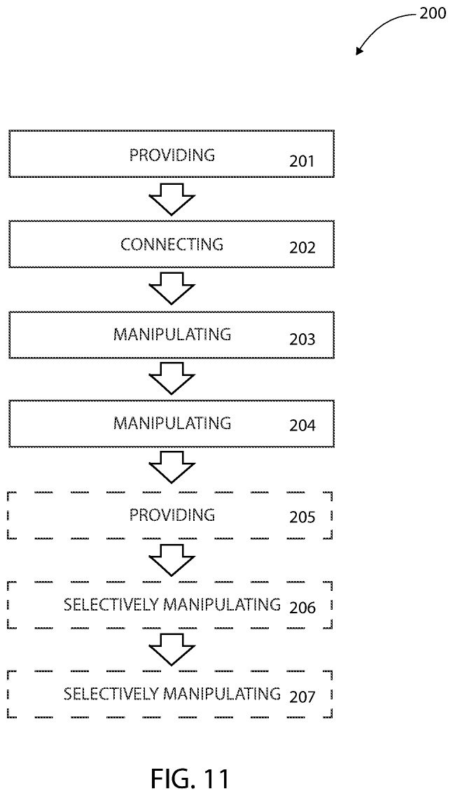

Referring now to FIG. 11 showing a flow diagram illustrating a method 200 of using a misting system for connection with a water supply, according to an embodiment of the present disclosure. In particular, the method 200 may include one or more components or features of the misting system 100 as described above. As illustrated, the method of use 200 may include the steps of: step 201, providing the misting system as above; step 202, connecting the water supply to the first water supply input; step 203, manipulating, when misting is desired, the first valve operator to open the at least one first valve, thereby causing said water to flow through the at least one first valve and out of each first misting end of the first plurality of anti-drip misting nozzles; and step 204, manipulating, when misting is not desired, the first valve operator to close the at least one first valve, thereby preventing said water to flow through the at least one first valve.

Further steps may include step 205, providing the misting system 100 comprising the at least one second water supply conduit, the second plurality of anti-drip misting nozzles and at least one second valve; step 206, selectively manipulating, when misting is desired, at least one of the first valve operator to open the at least one first valve and the second valve operator to open the at least one second valve; and step 207, selectively manipulating, when misting is not desired, the at least one of the first valve operator to close the at least one first valve and the second valve operator to close the at least one second valve.

As discussed above, the step of manipulating the second valve operator to open the at least one second valve may include applying weight to the second spring loaded button, and the step of manipulating the second valve operator to close the at least one second valve may include removing weight from the second spring loaded button. The step of manipulating the first valve operator to open the at least one second valve may include pressing or holding in the first spring loaded button, and the step of manipulating the first valve operator to close the at least one first valve may include pressing the first spring loaded button again.

It should be noted that certain steps are optional steps and may not be implemented in all cases. Optional steps of method 200 are illustrated using dotted lines in FIG. 11 so as to distinguish them from the other steps of method 200. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using the misting system and for providing mist to an area, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A misting system for connection with a water supply, the misting system comprising:
at least one support pipe including at least one fastener configured to attach the misting system to a surface, a plurality of first misting apertures and a first operator aperture;
a first water supply input configured to receive water from the water supply;
at least one first water supply conduit disposed within the at least one support pipe, the at least one first water supply conduit in communication with the first water supply input and configured to convey said water therefrom;
a first plurality of anti-drip misting nozzles arranged about the at least one first water supply conduit and configured to receive said water therefrom, each first anti-drip misting nozzle including a first conduit end opposite a first misting end, each first misting end being configured for insertion through a first misting aperture from the first plurality of misting apertures and to output said water therethrough; and
at least one first valve disposed along the at least one first water supply conduit, the at least one first valve including a first valve operator configured for insertion through the first operator aperture such that a user is able to selectively manipulate the first valve operator to one of open the at least one first valve thereby allowing said water to flow through the at least one first valve and out of each first misting end of the first plurality of anti-drip misting nozzles, and close the at least one first valve thereby preventing said water from flowing through the at least one first valve.

2. The misting system of claim 1, further comprising a base, wherein the base further includes a second water supply input.

3. The misting system of claim 2, wherein the base includes least one second water supply conduit disposed within the base, a second plurality of misting apertures and a second operator aperture, the at least one second water supply conduit in communication with the second water supply input and configured to convey said water therefrom.

4. The misting system of claim 3, further comprising a second plurality of anti-drip misting nozzles arranged about the base and connected to the at least one second water supply conduit to receive said water therefrom, each second anti-drip misting nozzles including a second conduit end opposite a second misting end, each second misting end being configured for insertion through a second misting aperture from the second plurality of misting apertures and configured to output said water therethrough.

5. The misting system of claim 4, at least one second valve disposed along the at least one second water supply conduit, the at least one valve including a second valve operator configured for insertion through the second operator aperture such that the user is able to selectively manipulate the second valve operator to one of open the at least one second valve thereby allowing said water to flow through the at least one second valve and out of each misting end of the second plurality of anti-drip misting nozzles, and close the at least one second valve thereby preventing said water from flowing through the at least one second valve.

6. The misting system of claim 5, wherein the second valve operator includes a second spring loaded button, wherein when weight is applied to the second spring loaded button, the at least one second valve opens, and wherein when weight is removed from the second spring loaded button, the at least one second valve closes.

7. The misting system of claim 6, wherein the first valve operator includes a first spring loaded button, wherein when the first spring loaded button is pressed, the at least one first valve opens, and wherein when the first spring loaded button is pressed again, the at least one first valve closes.

8. The misting system of claim 1, wherein the at least one fastener includes two screws.

9. The misting system of claim 8, wherein each of the two screws includes a block mount attached thereto.

10. A misting system for connection with a water supply, the misting system comprising:
a base including a second water supply input configured to receive water from the water supply, a second plurality of misting apertures and a second operator aperture;
at least one support pipe including at least one fastener configured to attach the misting system to a surface, a plurality of first misting apertures and a first operator aperture;
a first water supply input configured to receive water from the water supply;
at least one first water supply conduit disposed with the at least one support pipe, the at least one first water supply conduit in communication with the first water supply input and configured to convey said water therefrom;
a first plurality of anti-drip misting nozzles arranged about the at least one first water supply conduit and configured to receive said water therefrom, each first anti-drip misting nozzle including a first conduit end opposite a first misting end, each first misting end being configured for insertion through a first misting aperture from the first plurality of misting apertures and to output said water therethrough;
at least one first valve disposed along the at least one first water supply conduit, the at least one first valve including a first valve operator configured for insertion through the first operator aperture such that a user is able to selectively manipulate the first valve operator to one of open the at least one first valve thereby allowing said water to flow through the at least one first valve and out of each first misting end of the first plurality of anti-drip misting nozzles, and close the at least one first valve thereby preventing said water from flowing through the at least one first valve;
at least one second water supply conduit disposed within the base, the at least one second water supply conduit in communication with the second water supply input and configured to convey said water therefrom;
a second plurality of anti-drip misting nozzles arranged about the base and connected to the at least one second water supply conduit to receive said water therefrom, each anti-drip misting nozzles including a conduit end opposite a misting end, each misting end being configured for insertion through a misting aperture from the second plurality of misting apertures and configured to output said water therethrough; and
at least one second valve disposed along the at least one second water supply conduit, the at least one valve including a second valve operator configured for insertion through the second operator aperture such that the user is able to selectively manipulate the second valve operator to one of open the at least one second valve thereby allowing said water to flow through the at least one second valve and out of each misting end of the second plurality of anti-drip misting nozzles, and close the at least one second valve thereby preventing said water from flowing through the at least one second valve.

11. The misting system of claim 10, wherein the second valve operator includes a second spring loaded button, wherein when weight is applied to the second spring loaded button, the at least one second valve opens, and wherein when weight is removed from the second spring loaded button, the at least one second valve closes.

12. The misting system of claim 11, wherein the first valve operator includes a first spring loaded button, wherein when the first spring loaded button is pressed, the at least one first valve opens, and wherein when the first spring loaded button is pressed again, the at least one first valve closes.

13. The misting system of claim 10, wherein the at least one fastener includes two screws.

14. The misting system of claim 13, wherein each of the two screws includes a block mount attached thereto.

15. A method of using a misting system for connection with a water supply, the method comprising the steps of:
providing the misting system including:
at least one support pipe including at least one fastener configured to attach the misting system to a surface, a plurality of first misting apertures and a first operator aperture;
a first water supply input configured to receive water from the water supply;
at least one first water supply conduit disposed within the at least one support pipe, the at least one first water supply conduit in communication with the first water supply input and configured to convey said water therefrom;
a first plurality of anti-drip misting nozzles arranged about the at least one first water supply conduit and configured to receive said water therefrom, each first anti-drip misting nozzle including a first conduit end opposite a first misting end, each first misting end being configured for insertion through a first misting aperture from the first plurality of misting apertures and to output said water therethrough; and
at least one first valve disposed along the at least one first water supply conduit, the at least one first valve including a first valve operator configured for insertion through the first operator aperture such that a user is able to selectively manipulate the first valve operator to one of open the at least one first valve thereby allowing said water to flow through the at least one first valve and out of each first misting end of the first plurality of anti-drip misting nozzles, and close the at least one first valve thereby preventing said water from flowing through the at least one first valve;
connecting the water supply to the first water supply input;
manipulating, when misting is desired, the first valve operator to open the at least one first valve, thereby causing said water to flow through the at least one first valve and out of each first misting end of the first plurality of anti-drip misting nozzles; and
manipulating, when misting is not desired, the first valve operator to close the at least one first valve, thereby preventing said water to flow through the at least one first valve.

16. The method of claim 15, further comprising the steps of:
providing the misting system further comprising:
a base including a second water supply input configured to receive water from the water supply, a second plurality of misting apertures and a second operator aperture;
at least one second water supply conduit disposed within the base, the at least one second water supply conduit in communication with the second water supply input and configured to convey said water therefrom;
a second plurality of anti-drip misting nozzles arranged about the base and connected to the at least one second water supply conduit to receive said water therefrom, each anti-drip misting nozzles including a conduit end opposite a misting end, each misting end being configured for insertion through a misting aperture from the second plurality of misting apertures and configured to output said water therethrough; and
at least one second valve disposed along the at least one second water supply conduit, the at least one valve including a second valve operator configured for insertion through the second operator aperture such that the user is able to selectively manipulate the second valve operator to one of open the at least one second valve thereby allowing said water to flow through the at least one second valve and out of each misting end of the second plurality of anti-drip misting nozzles, and close the at least one second valve thereby preventing said water from flowing through the at least one second valve;
selectively manipulating, when misting is desired, at least one of the the first valve operator to open the at least one first valve and the second valve operator to open the at least one second valve; and
selectively manipulating, when misting is not desired, the at least one of the first valve operator to close the at least one first valve and the second valve operator to close the at least one second valve.

17. The method of claim 16, wherein the second valve operator includes a second spring loaded button, wherein the step of manipulating the second valve operator to open the at least one second valve includes applying weight to the second spring loaded button, and wherein the step of manipulating the second valve operator to close the at least one second valve includes removing weight from the second spring loaded button.

18. The method of claim 17, wherein the first valve operator includes a first spring loaded button, wherein the step of manipulating the first valve operator to open the at least one second valve includes pressing the first spring loaded button, and wherein the step of manipulating the first valve operator to close the at least one first valve includes pressing the first spring loaded button again.

19. The method of claim 15, wherein the at least one fastener includes two screws.

20. The method of claim 19, wherein each of the two screws includes a block mount attached thereto.
